(19) United States
(12) Patent Application Publication
(10) Pub. No.: US 2008/0239726 A1
(43) Pub. Date: Oct. 2, 2008

(54) LED projection lamp for stage use

(76) Inventor: Yung-Fa Cheng, Dongguan City (CN)

Correspondence Address: CHARLES E. BAXLEY, ESQUIRE, 90 JOHN STREET, SUITE 309, NEW YORK, NY, 10038, US

(21) Appl. No.: 11/903,825

(22) Filed: Sep. 24, 2007

(30) Foreign Application Priority Data
Mar. 26, 2007 (CN) 200720049587.0

(51) Int. Cl. F21V 3/00

(52) U.S. Cl. 362/311

(57) ABSTRACT

The present invention relates to a LED projection lamp for stage use which is of low energy consumption and high stability, wherein the light emission of LED is controlled by program, a fresnel lens is provided in front of the LED so as to project a geometrical figure in certain distance, which is of long lifetime and high reliability. The present invention comprises a lamp body, wherein the lamp body is provided with a program control PCB, the program control PCB is electrically connected to a LED panel, the LED panel is provided on the lamp body, a fresnel lens is provided in the front portion of the lamp body. With the present invention, a geometrical figure can be obtained in a certain distance. The present invention is of simple configuration and high stability.

### BACKGROUND OF THE INVENTION

The present invention relates to a projection lamp for using on the stage, in particular to a stage projection lamp using LED as the light source.

In the modern theater, apparatuses such as spotlights, imaging lamps, special effect lamps and digital color change devices are used together at the positions of the ceiling light and the light projection. The spotlight, the imaging lamp and the zoom lamp along with the color change device are selected to be used as ceiling light in some theaters so as to improve the performance of lighting. Presently, LEDs (light-emitting diode)are all used as background light sources on the stage to replace the known lamps. New energy saving light source is desired to replace the projection lamp with high power so as to solve the problem of soft light.

### SUMMARY OF THE INVENTION

Having outlined the state of the prior art and its attendant shortages, it is the object of the present invention to provide a LED projection lamp for stage use which is of low energy consumption and high stability, wherein the light emission of LED is controlled by program, a fresnel lens is provided in front of the LED so as to project a geometrical figure in certain distance, which is of long lifetime and high reliability.

A LED projection lamp for stage use comprises a lamp body. The lamp body is provided with a program control PCB. The program control PCB is electrically connected to a LED panel. The LED panel is mounted on the lamp body. A fresnel lens is provided in the front portion of the lamp body.

Furthermore, the fresnel lens is provided in front of the LED panel.

Furthermore, the lamp body is provided with a switching power supply which is electrically connected to the program control PCB.

Furthermore, the switching power supply is provided with a rectifying circuit.

In the situation that a fresnel lens is not provided in front of the LED, only a bright figure with small size could be displayed. The present invention having the fresnel lens is capable to project the figure in long distance and enlarge the figure; in the environment where a smoke machine is in use, the beams of light can be clearly seen. According to the present invention, the LED is used for projecting the figure, a fresnel lens is used in the stage projection lamp, the fresnel lens is made of PMMA (Polymethyl Methacrylate) and used for projecting the LED so as to obtain a geometrical figure in a certain distance. The present invention is of simple configuration and high stability.

### BRIEF DESCRIPTION OF THE DRAWINGS

FIG. 1 is a structural schematic view of an embodiment of the present invention;

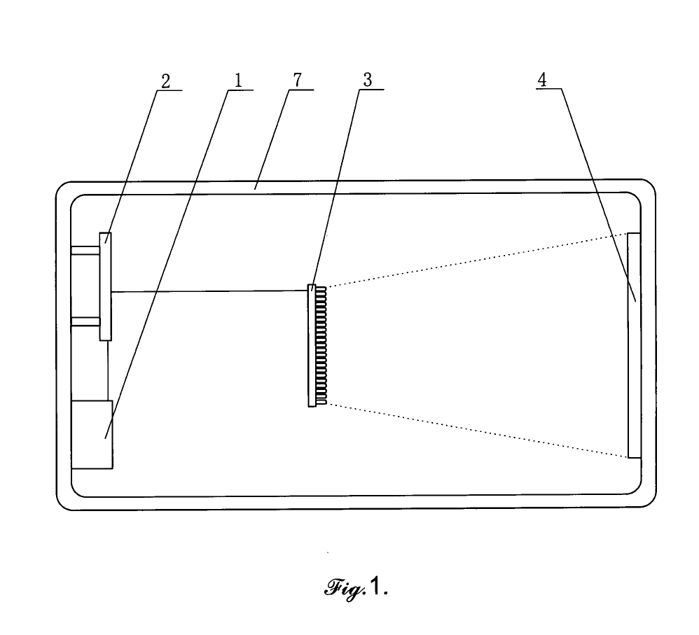

FIG. 2 is a schematic view showing the operation of an embodiment of the present invention.

### DETAILED DESCRIPTION OF THE INVENTION

The invention may be more fully understood from the following description of a preferred embodiment made with reference to the accompanying figures.

The present invention mainly comprise the following parts (or devices): a switching power supply 1, a program control PCB 2, a LED panel 3, a fresnel lens 4, a LED light source 5, a lamp body 6, beams of light 7.

The lamp body 6 is provided with a program control PCB 2 which is electrically connected to the LED panel 3. The LED panel 3 is provided on the lamp body 6 in the front portion of which the fresnel lens 4 is provided.

The fresnel lens 4 is provided in front of the LED panel 3. The lamp body 6 provided with the switching power supply 1 which is electrically connected to the program control PCB 2. The switching power supply is provided with a rectifying circuit.

The power is input into the switching power supply for rectification, and then the current travel through the program control PCB 2, and the electrical signal after being controlled and processed by the program control PCB 2 is input into the LED panel 3 so as to allow the LED to emit light with different chromaticity, and then the effective projection is carried out by the fresnel lens 4.

The fresnel lens is also called echelon lens, that is to say, the lens has a discontinuous surface of echelon shape that is formed of a series of concentric zone, which is also called zone lens.

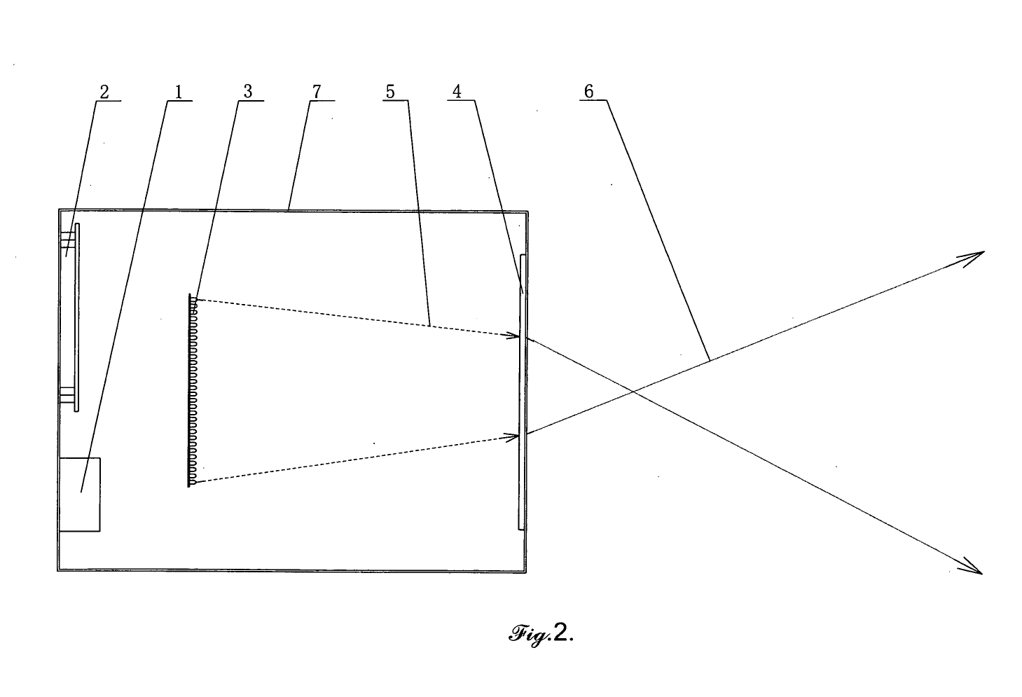

Referring to FIG. 2, the LED panel 3 is a lamp panel which consists of LEDs. The LED light source 5 is a light source emitted by LED, and the effective beams of light 7 is obtained after the light beams travel through the fresnel lens, and finally projected figure is obtained. The profile of light beams is soft.

What is claimed is:

1. A LED projection lamp for stage use, comprising a lamp body, wherein the lamp body is provided with a program control PCB, the program control PCB is electrically connected to a LED panel, the LED panel is provided on the lamp body, a fresnel lens is provided in the front portion of the lamp body.

2. The LED projection lamp for stage use of claim 1, wherein the fresnel lens is provided in front of the LED panel.

3. The LED projection lamp for stage use of claim 1, wherein the lamp body is provided with a switching power supply, the switching power supply is electrically connected to the program control PCB.

4. The LED projection lamp for stage use of claim 1, wherein the switching power supply is provided with a rectifying circuit.
